(19) United States
(12) Patent Application Publication
(10) Pub. No.: US 2009/0145456 A1
(43) Pub. Date: Jun. 11, 2009

(54) Ultrasonic Bubble Reduction System

(76) Inventors: Kevin D. Beebe, Spencerport, NY (US); Matthew M. Place, Hilton, NY (US); Travis M. Fisher, Webster, NY (US); Michael J. Moorehead, Fairport, NY (US)

Correspondence Address: Bausch & Lomb Incorporated, One Bausch & Lomb Place, Rochester, NY, 14604-2701, US

(21) Appl. No.: 12/325,347

(22) Filed: Dec. 1, 2008

Related U.S. Application Data
(60) Provisional application No. 61/012,488, filed on Dec. 10, 2007.

(51) Int. Cl. B08B 3/12; B08B 13/00

(52) U.S. Cl. 134/1; 134/113

(57) ABSTRACT

An inspection system includes an inspection station configured to receive a plurality of ophthalmic devices, and a fluid supply fluidly connected to the inspection station. The fluid supply contains a working fluid. The system also includes an ultrasonic degassing assembly configured to remove at least one bubble carried by the plurality of ophthalmic devices upstream of a packaging station.

### CROSS-REFERENCE TO RELATED APPLICATIONS

This application claims the benefit of Provisional Patent Application No. 61/012,488 filed on Dec. 10, 2007 which is incorporated by reference herein.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to equipment used to manufacture ophthalmic devices, and, in particular, to equipment used to manufacture contact lenses.

2. Description of Related Art

Soft hydrogel contact lenses have increased in popularity since they were first introduced in the 1970s. Such contact lenses are conventionally formed through a process in which the material used to make the lenses is placed between two halves of a casting mold, and the entire assembly is then cured to form the desired contact lens shape. After the curing process, the lens is removed from the casting mold and is immersed in a series of fluids to remove impurities therefrom. While still immersed in fluid, the lens is taken to an examination station where it is inspected for foreign particles, holes, and/or deformations caused by the manufacturing process.

Existing systems for the inspection of contact lenses typically include a lens transportation device, a camera, a viewing monitor, and a computer. The computer is configured to run lens examination software which controls the camera during a lens inspection process. In examining the lens, the camera and, in particular, the software, can inspect the lens surfaces for the foreign particles, holes, and deformities discussed above, and the software can control the inspection system to reject a lens if such deformities are found thereon.

Although existing inspection systems have some utility in a contact lens production environment, reliance on such systems can result in a large number of false lens rejections during production. For example, the camera and, in particular, the camera software can not be capable of distinguishing a hole, a foreign particle, or other lens deformities from gas bubbles that have adhered to the surface of the lens. Bubbles can be formed by, for example, turbulent working fluid 42 flow within the various systems used for impurity removal. In such systems, air and other gases can become entrained within the working fluid 42 and high fluid pressures can not allow the entrained air to expand and escape from the working fluid 42. Depending on the type of contact lens being examined and the throughput of the manufacturing line, false lens rejections caused by existing camera inspection systems can dramatically increase production costs and can severely hinder manufacturing efficiency.

Accordingly, the disclosed systems and methods are directed towards overcoming one or more of the problems set forth above.

### SUMMARY OF THE INVENTION

In an exemplary embodiment of the present disclosure, an inspection system includes an inspection station configured to receive a plurality of ophthalmic devices, and a fluid supply fluidly connected to the inspection station. The fluid supply contains a working fluid. The system also includes an ultrasonic degassing assembly configured to remove at least one bubble carried by the plurality of ophthalmic devices upstream of a packaging station.

In another exemplary embodiment of the present disclosure, a method of inspecting an ophthalmic device includes disposing the ophthalmic device within a volume of working fluid and directing ultrasonic energy to the ophthalmic device through the working fluid prior to disposing the ophthalmic device in a packaging container. The method also includes sensing at least one characteristic of the ophthalmic device.

In still another exemplary embodiment of the present disclosure, a method of inspecting an ophthalmic device includes submerging a portion of a probe of an ultrasonic degassing assembly in a volume of working fluid disposed in an inspection station and positioning the probe proximate a bubble formed within the volume of working fluid, the bubble disposed on a surface of the ophthalmic device. The method also includes directing ultrasonic energy to the bubble with the probe, removing the portion of the probe from the volume of working fluid, and sensing at least one characteristic of the surface.

### BRIEF DESCRIPTION OF THE DRAWINGS

FIG. 1 is a partial diagrammatic illustration of an ophthalmic device forming system according to an exemplary embodiment of the present disclosure.

FIG. 2 is a partial diagrammatic illustration of a portion of the system shown in FIG. 1.

### DETAILED DESCRIPTION OF THE DRAWINGS

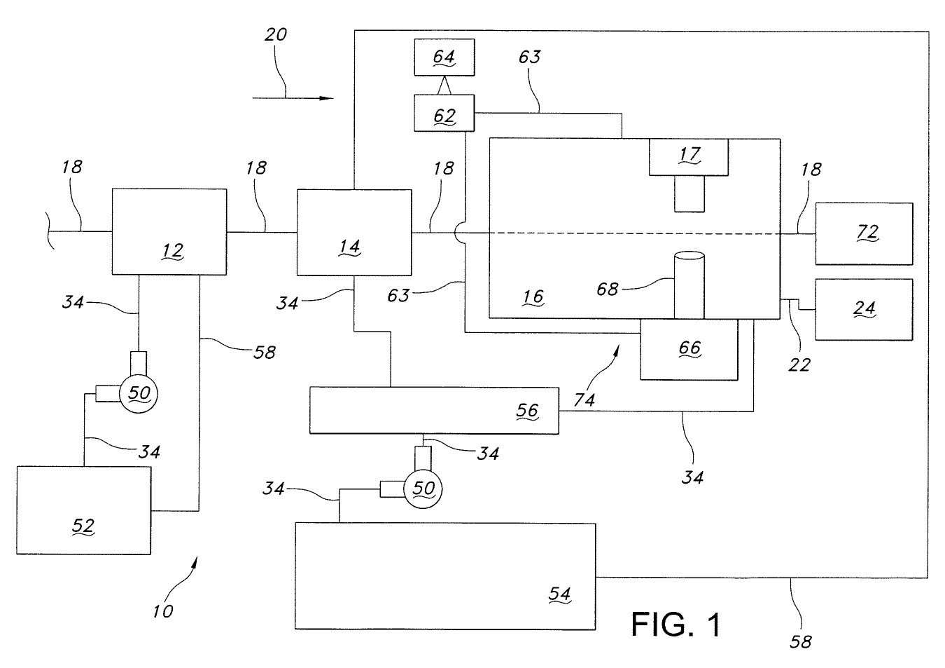

FIG. 1 illustrates an ophthalmic device forming system 10 according to an exemplary embodiment of the present disclosure. As shown in FIG. 1, the system 10 includes, for example, a water bath 12, a cleanser 14, an inspection station 16, and a packaging station 72. The water bath 12 can be connected to the cleanser 14 via a transport device 18 and the cleanser 14 can be connected to the inspection station 16 by the transport device 18. The packaging station 72 can also be connected to the inspection station 16 via the transport device 18. As shown in FIG. 1, the water bath 12 can be disposed upstream of the cleanser 14, the cleanser 14 can be disposed upstream of the inspection station 16, and the packaging station 72 can be disposed downstream of the inspection station 16. The system 10 can also include an ultrasonic degassing assembly 74. In an exemplary embodiment, the ultrasonic degassing assembly 74 can include a power source 66 and a probe 68.

In forming an ophthalmic device such as, for example, a contact lens, casting molds can be dosed with a monomer, a polymer, and/or other lens forming materials. The entire casting mold assembly can then be placed into a curing apparatus where the ophthalmic device can be formed and/or otherwise cured. Once the lens is formed, a posterior portion of the casting mold can be removed and discarded, and the formed lens can be substantially adhered to the remaining or anterior portion of the casting mold. The lens and the anterior portion of the casting mold can then be placed in, for example, a solvent reduction oven where the lens and the anterior portion of the casting mold are immersed in a solvent to assist in separation. A plunger mechanism can then be used to apply a pressure to a portion of the anterior portion of the casting mold and a vacuum device can be used to remove the separate lens. The anterior portion of the casting mold can then be discarded and the formed lens can be transported to an edge forming apparatus wherein at least a portion of the substantially circular edges of the lens are rounded. The lens can then be coated with a plasma and/or other lens coating materials, and the coated lens can be transported to one or more machines configured to assist in removing impurities and inspecting the condition of the lens.

In an exemplary embodiment, a coated lens can first be transported to the water bath 12 via the transport device 18. The transport device 18 can be any apparatus and/or collection of machines or devices useful in transporting items having optical quality surfaces from one machine to another machine in an assembly and/or manufacturing environment. The transport device 18 can include one or more gripping devices such as, for example, fingers, hooks, graspers, and/or any other gripping devices known in the art. Such gripping devices (not shown) can be configured to delicately grasp a fragile item such as, for example, a partially formed ophthalmic device and safely transport the fragile item from machine to machine without causing damage thereto. In an exemplary embodiment, the transport device 18 can also include one or more vacuum devices (not shown). The vacuum devices can be configured to handle and/or otherwise grasp the ophthalmic devices while not causing any damage to the one or more optical quality surfaces of the ophthalmic devices during transport.

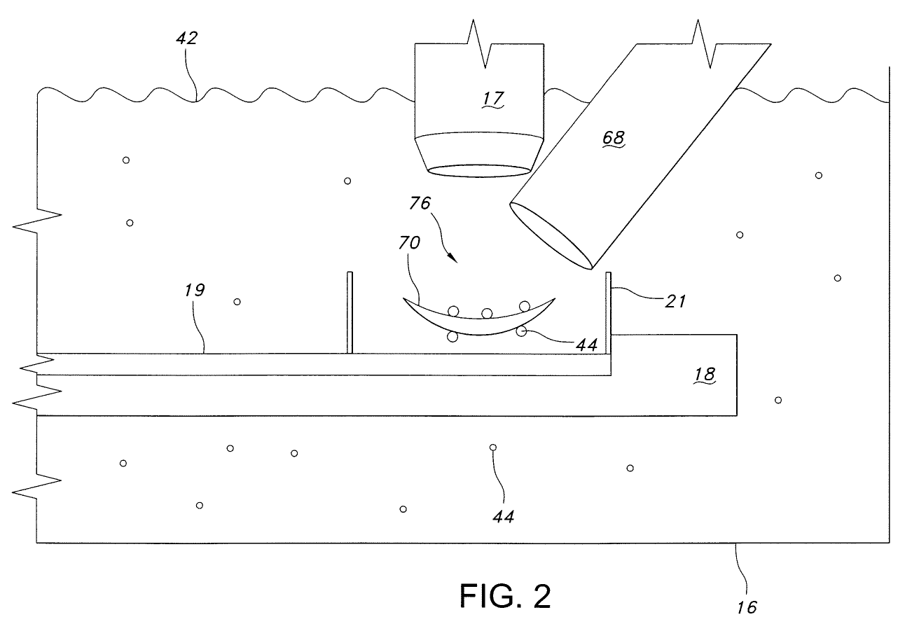

As shown in FIG. 2, in an additional exemplary embodiment of the present disclosure, the ophthalmic devices 70 formed and/or inspected by the system 10 can be housed in one or more carrying trays 19. The carrying trays 19 can be transported from, for example, the water bath 12 to the cleanser 14 and then to the inspection station 16 by the transport device 18. In such an exemplary embodiment, the transport device 18 can be configured to transport the carrying trays 19 between the components of the system 10 without causing any damage to, for example, the carrying trays 19 and/or the ophthalmic devices 70 carried thereby. The carrying trays 19 can comprise a plurality of substantially open cells 21, each configured to retain an ophthalmic device 70. In an exemplary embodiment, each carrying tray 19 may define sixteen or more cells 21, and it is understood that the substantially open cells 21 can include at least one open section 76 through which the ophthalmic device 70 can be relatively easily accessed by. In an exemplary embodiment, the working fluid 42 disposed within the inspection station 16 and/or a probe 68 of the ultrasonic degassing assembly 74 may access the ophthalmic device 70 via the open section 76. The substantially open cells 21 can also enable the easy insertion and removal of an ophthalmic device 70 relative to the cell 21. Accordingly, the substantially open cells 21 may enable the probe 68 of the ultrasonic degassing assembly 74 to assist in removing gas bubbles adhered to and/or otherwise carried with the ophthalmic devices 70 prior to packaging of the devices 70 at the packaging station 72. The cells 21 may also enable wet inspection of ophthalmic devices 70 prior to packaging of the devices 70 at the packaging station 72.

Alternatively, as discussed above, the transport device 18 can also be configured to transport ophthalmic devices 70 individually between the components of the system 10. In such an alternative exemplary embodiment, the carrying trays 19 can be omitted.

Referring again to FIG. 1, the water bath 12 can be any device known in the art configured to assist in fluidly removing debris, contaminants, and/or other foreign materials from an ophthalmic device such as, for example, a contact lens. Such foreign materials may be adhered to and/or otherwise carried with the ophthalmic device in an ophthalmic device forming process, and the foreign materials can be, for example, dirt, dust, and/or pieces of polymer or monomer material left over from upstream ophthalmic device forming and/or curing processes. In an exemplary embodiment, the water bath 12 can be configured to remove isopropyl alcohol from the ophthalmic devices transported thereto. Isopropyl alcohol can be carried with the ophthalmic devices from components of the system 10 disposed upstream of the water bath 12. The water bath 12 can be configured to receive ophthalmic devices 70 and/or other devices or carrying trays 19 (FIG. 2) transported by the transport device 18.

The water bath 12 can include a housing and/or other components configured to receive and retain working fluid 42 such as, for example, water, isopropyl alcohol, saline solution and/or other cleansing or hydrating agents. The housing of the water bath 12 can be made from any metal and/or alloy known in the art such as, for example, FDA approved 316 stainless steel. The water bath 12 can be fluidly connected to a fluid supply 52 configured to store the working fluid 42 discussed above and/or direct a pressurized flow of the working fluid 42 to the water bath 12. The water bath 12 can also include one or more pressurization devices (not shown) configured to direct the working fluid 42 supplied from the fluid supply 52 towards the ophthalmic devices 70 delivered by the transportation device 18. In an exemplary embodiment, the pressurization devices can include one or more nozzles or other like structures.

The fluid supply 52 can be any drum, container, sump, or other fluid storage device known in the art configured to house and/or otherwise store a large volume of working fluid 42. In an exemplary embodiment, fluid supply 52 can be a fluid supply of the manufacturing facility in which the system 10 is operating. In such an exemplary embodiment, the fluid supply 52 can be a water tower or other like fluid storage device. As shown in FIG. 1, the fluid supply 52 can be fluidly connected to the water bath 12 via one or more supply lines 34. The supply lines 34 can be any tube, pipe, hose, and/or other structure known in the art configured to transmit a pressurized flow of fluid between two components in a production environment. The supply lines 34 can be made from any metal, alloy, plastic, and/or other material useful for transmitting pressurized flows of fluid, and such materials may include, PVC, copper, and FDA approved 316 stainless steel. In an exemplary embodiment, the supply lines 34 can be substantially rigid pipes. Alternatively, the supply lines 34 can be a combination of substantially rigid piping and substantially flexible hoses. The water bath 12 can also be fluidly connected to the supply 52 via a return line 58 configured to direct a flow of working fluid 42 from the water bath 12 to the fluid supply 52. The return line 58 can be mechanically similar to the supply lines 34 described above. In addition, it is understood that the fluid supply lines 34 and the return line 58 can include a number of valves and/or joints to assist in fluidly connecting the water bath 12 to the fluid supply 52.

A pump 50 can be fluidly connected between the fluid supply 52 and the water bath 12. The pump 50 can be configured to draw working fluid 42 from the fluid supply 12 and to supply a pressurized flow of the working fluid 42 to the water bath 12 via the supply lines 34. The pump 50 can be any fluid pressurization device known in the art such as, for example, a positive displacement pump or a rotodynamic pump. The pump 50 can also include a power source such as, for example, an electric motor configured to supply rotary power to, for example, an input shaft of the pump 50.

Referring again to FIG. 1, the cleanser 14 can be disposed adjacent to the water bath 12 and can be configured to receive ophthalmic devices 70 and/or other devices or carrying trays 19 transported by the transport device 18. The cleanser 14 can include a housing and/or other components configured to contain fluids such as, for example, water. The cleanser 14 can be similar in construction to the water bath 12 and can be configured to cleanse and/or otherwise remove impurities from the ophthalmic devices 70 transported thereto. In an exemplary embodiment, the cleanser 14 can also include a cleansing agent supply and one or more pressurization devices (not shown). In an exemplary embodiment, the pressurization devices can include one or more nozzles or other like structures. The pressurization devices can be configured to inject and/or otherwise combine a mild soap-like cleaning agent or other cleaning agent with the working fluid 42 supplied from the fluid supply 52. A working fluid 42/cleaning agent mixture can, thus, be directed towards the ophthalmic devices 70 within a portion of the cleanser 14 to remove impurities from the devices 70.

As discussed above with respect to the water bath 12, the cleanser 14 can be fluidly connected to a fluid supply 54. The fluid supply 54 can be, for example, a tank, container and/or any other device configured to store and/or retain a supply of fluid such as, for example, water or other working fluids 42.

As shown in FIG. 1, a pump 50 can be configured to draw working fluid 42 from the fluid supply 54 and to supply a pressurized flow of working fluid 42 to the cleanser 14. In an exemplary embodiment, the pump 50 can be configured to direct a pressurized flow of working fluid 42 to a header 56. The header 56 can be, for example, a manifold or other device useful in delivering a pressurized flow of fluid to a plurality of components. The cleanser 14, header 56, and/or fluid supply 54 can be made from any of the materials discussed above with respect to the supply line 34 and return line 58. In an exemplary embodiment, the cleanser 14, header 56, and/or fluid supply 54 can be made from FDA approved 316 stainless steel or other like metals or alloys. The pump 50 connecting the fluid supply 54 to the header 56 can be substantially similar to the pump 50 connecting the fluid supply 52 to the water bath 12. In an additional exemplary embodiment, the pump 50 fluidly connected to the fluid supply 54 can have a greater pumping capacity than the pump 50 fluidly connected to the fluid supply 52. As shown in FIG. 1, working fluid 42 from the fluid supply 54 can be directed to the cleanser 14 via supply lines 34 and working fluid 42 exiting in the cleanser 14 can be returned to the fluid supply 54 via the return line 58.

The inspection station 16 can be disposed adjacent to the cleanser 14, and cleaned ophthalmic devices 70, carrying trays 19, and/or other ophthalmic device handling components can be transported from the cleanser 14 to the inspection station 16 by the transport device 18. The inspection station 16 can be any conventional inspection station or apparatus known in the art. The inspection station 16 can include, for example, a housing similar to the housings described above with respect to the water bath 12 and the cleanser 14. The inspection station 16 can be configured to receive a pressurized flow of working fluid 42 from the fluid supply 54. As shown in FIG. 1, a supply line 34 can be configured to direct a pressurized flow of the working fluid 42 from the header 56 to the inspection station 16. It is understood that, in an exemplary embodiment, the inspection station 16 and/or the cleanser 14 can be connected to dedicated pumps 50. In such an exemplary embodiment, the header 56 can be removed, and the cleanser 14 and/or the inspection station 16 and their corresponding pumps 50 can be connected directly to the fluid supply 54.

As shown in FIGS. 1 and 2, the ultrasonic degassing assembly 74 can be disposed proximate and/or at least partially connected to the inspection station 16. The ultrasonic degassing assembly 74 be configured to assist in removing gases entrained within the working fluid 42 disposed within the inspection station 16. As discussed above, in an exemplary embodiment, the assembly 74 can include a power source 66 and a probe 68. The probe 68 can be, for example, any known ultrasonic tool configured to desirably concentrate, direct, and/or focus ultrasonic energy. The probe 68 can be any shape, size, and/or other configuration known in the art and can include a diameter that is substantially equal to a diameter of the ophthalmic device 70 being inspected.

In an exemplary embodiment, the probe 68 and/or other components of the ultrasonic degassing assembly 74 can be controllably and/or otherwise programmably movable relative to the transport device 18 and/or the ophthalmic devices 70 transported thereby. The probe 68 can be, for example, mounted to tracks, motors, belts, robot arms, and/or other devices (not shown) configured to enable relative movement between the probe 68 and ophthalmic devices 70 delivered to the inspection station 16. Components of the ultrasonic degassing assembly 74 such as, for example, the probe 68, can also be electrically connected to, for example, a controller 62 (described in further detail below) configured to assist in controlling the position, focus, activation, and/or deactivation thereof.

In an exemplary embodiment of the present disclosure, the probe 68 can be configured to direct ultrasonic energy to the ophthalmic device 70 through the working fluid 42, and can assist in creating a pressure difference between the working fluid 42 and entrained gases forming one or more bubbles 44 on a surface of the ophthalmic device 42. The pressure difference created by the probe 68 can be large enough to cause a dimension, volume, surface area, and/or other quantifiable aspect of the bubbles 44 such as, for example, a diameter thereof, to increase. It is understood that once the working fluid pressure (i.e., the pressure on the outside of the bubbles 44) exceeds that of the pressure within the bubbles 44, the bubbles 44 will burst. In an exemplary embodiment, each bubble 44, depending on its size, may have a different internal pressure. In such an exemplary embodiment, the probe 68 can be configured to assist in creating a variable pressure difference between the working fluid 42 and the entrained gases.

The gases released from the bursted bubbles 44 can, for example, diffuse into the working fluid 42 and/or collect within a portion of the inspection station 16. In an exemplary embodiment, the released gases can freely diffuse into the working fluid 42 as a result of the working fluid 42 being previously degassed. Previously degassing the working fluid 42 can result in the fluid 42 having a relatively low saturation level and, thus, enabling the fluid 42 to absorb the released gases relatively easily.

Although not shown in FIGS. 1 and 2, it is understood that the inspection station can be fluidly connected to, for example, a vacuum source or other component configured to remove released gases therefrom. Alternatively, the released gases can collect within the inspection station 16 and can be vented to atmosphere or to the manufacturing facility in which the system 10 is operating. The released gases can include any gases commonly found in the earth's atmosphere such as, for example, oxygen, carbon dioxide, and air. In addition, the working fluid 42 can be any fluid known in the art such as, for example, de-ionized water, isopropyl alcohol, saline solution, and/or any other hydrating and/or cleansing agent.

The power source 66 of the ultrasonic degassing assembly 74 can be any ultrasonic generator and/or other power source known in the art configured to emit ultrasonic energy at a desirable frequency, wavelength, and/or amplitude.

The inspection station 16 can also include at least one sensor 17. The sensor 17 can be any diagnostic device such as, for example, a thermocouple, a camera, and/or a pressure sensor, configured to sense one or more characteristics of an ophthalmic device 70. In an exemplary embodiment, the sensor 17 can be a high resolution camera and/or other video, photographic, or image sensing device configured to sense, measure, and/or otherwise analyze a surface of an ophthalmic device delivered in proximity thereto. The inspection station 16 can be configured to direct and/or otherwise immerse ophthalmic devices 70 delivered thereto via the transport device 18 in a volume of working fluid 42 supplied by the fluid supply 54. Accordingly, the sensor 17 can be configured to obtain images of the ophthalmic devices 70 in a substantially aqueous environment. It is understood that the transport device 18 can enable the ophthalmic devices 70 transported thereby to be movable relative to the inspection station 16.

Similar to the probe 68 and/or other components of the ultrasonic degassing assembly 74, the sensor 17 can be configured and/or otherwise mounted within the inspection station 16 to be controllably and/or otherwise programmably movable relative to the transport device 18 and/or the ophthalmic devices 70 transported thereby. The sensor 17 can be mounted to tracks, motors, belts, robot arms, and/or other devices (not shown) configured to enable relative movement between the sensor 17 and ophthalmic devices 70 delivered to the inspection station 16.

The sensor 17 can be electrically connected to the controller 62 of the system 10. The controller 62 can include, for example, an ECU, a computer, and/or any other electrical control device known in the art. The controller 78 can include one or more operator interfaces 64 such as, for example, a monitor, a keyboard, a mouse, a touch screen, and/or any other devices useful in entering, reading, storing, and/or extracting data from the devices to which the controller 62 is connected. The controller 62 can be configured to exercise one or more control algorithms and/or control the devices to which it is connected based on one or more preset programs. For example, the controller 62 can be configured to control the sensor 17 to obtain images of ophthalmic devices 70 delivered to the inspection station 16 via the transport device 18. The controller 62 can also be configured to operate and/or otherwise execute image software loaded thereon and configured to inspect the images obtained by the sensor for defects in the ophthalmic devices 70. The controller 62 can also be configured to store and/or collect images and/or other data regarding the ophthalmic devices 70 that are observed. Such data can assist a user in determining the quality and/or usability of the observed ophthalmic device.

The controller 62 can be connected to, for example, the sensor 17 and/or a component of the ultrasonic degassing assembly 74 via one or more connection lines 63. The pumps 50, the motors (not shown) connected to pumps 50, and/or other devices of the system 10 can also be electrically connected to the controller 62 via connection lines 63 (not shown). The connection lines 63 can consist of any conventional electrical connection means known in the art such as, for example, wires or other like connection structures, as well as wireless communication means. Through these electrical connections, the controller 62 can be configured to receive, for example, sensed image data from the sensor 17. In particular, the controller 62 can be configured to receive images of the optical quality surfaces of the ophthalmic devices 70 delivered to the inspection station 16 by the transport device 18. Based on the sensed images, the controller 62 can be configured to control the system 10 to accept the inspected ophthalmic for commercial sale or reject the ophthalmic devices 70 based on one or more detected impurities, lens deformations, and/or other ophthalmic device characteristics.

The transport device 18 can be configured to direct accepted ophthalmic devices 70 from the inspection station 16 to the packaging station 72 of the system 10. The packaging station 72 can be disposed downstream of the inspection station 16 and can be configured to package the accepted ophthalmic devices 70 into, for example, a blister package useful for commercial sale. The inspection station 16 can also be configured to direct the rejected ophthalmic devices 70 to a bin 24 via a transport device 22. The transport device 22 can be substantially similar in configuration to the transport device 18 and the bin 24 can be, for example, a reject bin of the system 10. Ophthalmic devices 70 directed to the bin 24 can be melted down and/or otherwise recycled for use in future ophthalmic device forming processes. Alternatively, the ophthalmic devices 70 directed to bin 24 can be discarded.

### INDUSTRIAL APPLICABILITY

The ophthalmic device forming system 10 of the present disclosure can be used with a series of other machines for the inspection and/or formation of ophthalmic devices 70 such as, for example, contact lenses. The system 10 can be configured for use with and/or otherwise included in, for example, an assembly line used to manufacture contact lenses and, in an exemplary embodiment, the system 10 can be used to inspect one or more ophthalmic devices 70 prior to packaging the devices 70 in a blister pack or other commercial sale container. Removing any large bubbles from the ophthalmic devices 70 can have many advantages including, for example, making it easier to place the devices 70 in the sales container since the devices 70 will be less likely to float when dispersed a solution.

In particular, an ultrasonic degassing assembly 74 of the present disclosure can be utilized to efficiently, reliably, and repeatably remove gas bubbles disposed upon, adhered to, and/or otherwise carried by one or more surfaces of the ophthalmic devices 70. Removing bubbles disposed upon the surfaces of the ophthalmic devices 70 prior to inspection can increase the accuracy with which defects are detected by components of the system 10 such as, for example, the sensor 17.

It is understood that, due to the turbulent flow of the working fluid 42, gases such as, for example, air can become entrained within the working fluid 42 delivered to, for example, the water bath 12, the cleanser 14, and/or the inspection station 16. Once entrained within the working fluid 42 these gases form the bubbles 44 illustrated in FIG. 2. Once the ophthalmic devices 70 are immersed within the working fluid 42, the bubbles 44 carried thereby can adhere to one or more surfaces of the ophthalmic devices 70 and can remain adhered to the ophthalmic devices 70 as the ophthalmic devices 70 are transported to the inspection station 16. Detection of the adhered bubbles 44 by the sensor 17 can result in the indication of a false negative on an otherwise acceptable ophthalmic device 70. Substantially eliminating the bubbles 44 with the ultrasonic degassing assembly 74, however, can substantially reduce the number of false negatives indicated by the system 10 and can thereby increase the efficiency and overall throughput thereof.

In an exemplary ophthalmic device inspection and/or forming process of the present disclosure, the transport device 18 can deliver one or more ophthalmic devices 70 to the water bath 12. For example, the transport device 18 can deliver a carrying tray 19 having sixteen cells 21, each cell 21 having an ophthalmic device 70 disposed therein. Upon receiving the ophthalmic devices 70, the pump 50 can be activated to supply a pressurized flow of working fluid 42 from the fluid supply 52, through supply line 34, to the water bath 12. The working fluid 42 can be, for example, de-ionized water or another lens cleaning agent. The water bath 12 can substantially immerse and/or otherwise wash the ophthalmic devices 70 therein with the pressurized flow of working fluid 42 such that substantially all impurities and/or other foreign objects are removed from the optical quality surfaces of the ophthalmic devices 70. In addition, the water bath 12 can assist in removing isopropyl alcohol carried by the ophthalmic devices 70. It is understood that, in an exemplary embodiment, isopropyl alcohol may be deposited on the ophthalmic devices 70 by system components disposed upstream of the water bath 12. A portion of the working fluid 42 supplied to the water bath 12 can return to the fluid supply 52 via the return line 58.

As illustrated by arrow 20 in FIG. 1, the ophthalmic devices 70 can then be transferred from the water bath 12 to the cleanser 14 via the transport device 18. It is understood that, as a result of the processes performed by the water bath 12, working fluid 42 utilized in the water bath 12 can be resident on one or more surfaces of the ophthalmic devices 70 transferred to the cleanser 14. Accordingly, the cleanser 14 can assist in substantially removing the working fluid 42, supplied by the water bath 12, from the ophthalmic devices 70. In an exemplary embodiment, the ophthalmic devices 70 can be immersed within a new supply of working fluid 42 directed to the cleanser 14 from the fluid supply 54. As discussed above, the working fluid 42 disposed within the fluid supply 54 can be de-ionized water, saline solution, and/or any other working fluid 42 that is acceptable and/or non-irritant to the human eye. The pump 50 can direct a pressurized flow of working fluid 42 to the cleanser 14 from the fluid supply 54 and, in an exemplary embodiment, the pump 50 can supply a pressurized flow of the working fluid 42 to the header 56 and the supply lines 34 can direct the pressurized flow to the cleanser 14. In addition, components of the cleanser 14 can direct a mild soap-like agent and/or other like lens cleaning agents to the ophthalmic devices. In an exemplary embodiment, the lens cleaning agents can be mixed with the pressurized flow of working fluid 42 delivered to the cleanser 14. Once the pressurized flow of working fluid 42 has been supplied to the cleanser 14, a portion of the working fluid 42 can be returned to the fluid supply 54 via the return line 58.

After the ophthalmic devices 70 have been acted upon by the cleanser 14, the ophthalmic devices 70 can then be transferred to the inspection station 16 by the transport device 18. The ophthalmic devices 70 can again be substantially submerged in a volume of working fluid 42 within the inspection station 16 so as not to dehydrate the ophthalmic devices 70 during inspection. As discussed above with respect to the water bath 12 and the cleanser 14, the flow of working fluid 42 directed to the inspection station 16 can be pressurized.

As discussed above, upon reaching the inspection station 16, a plurality of bubbles 44 can be attached to one or more surfaces of the ophthalmic devices 70. To assist in removing the bubbles 44, a portion of the probe 68 of the ultrasonic degassing assembly 74 can be at least partially submerged within the volume of working fluid within the inspection station 16. The probe 68 can be positioned proximate the surfaces of the ophthalmic devices 70 retaining the bubbles 44 either manually or under the direction of one or more position control algorithms executed by the controller 62. For example, the ophthalmic devices 70 disposed in separate cells 21 of a multi-cell carrying tray 19 can be acted on individually by the probe 68, and the probe 68 can be repositioned prior to acting on each of the ophthalmic devices 70 in the carrying tray 19. The carrying tray 19 and/or the transport device 18 can also be configured to rotate and/or otherwise assist in positioning the ophthalmic devices 70 relative to the probe 68.

Once the probe 68 has been properly positioned, the power source 66 can be activated to emit ultrasonic energy at a desired wavelength, frequency, and/or amplitude. The probe 68 can also be controlled to assist in concentrating and/or focusing the energy on the surfaces and or the bubbles 44 through the working fluid 42. The ultrasonic energy directed to the working fluid 42 can create a pressure difference between the working fluid 42 and the gases within the bubbles 42, and this pressure difference can cause a diameter of the bubbles 44 to increase. Eventually, the bubbles 44 will burst and the gases released can escape the working fluid 42.

Once substantially all of the bubbles 42 have been removed from the surfaces of the ophthalmic device 70, the probe 68 can be removed from the working fluid 42 and the sensor 17 can sense and/or otherwise detect a characteristic of the ophthalmic devices 70. As discussed above, such a characteristic can include, for example, surface quality, diameter, and/or other detectable characteristics. Such a characteristic could also include, for example, any trademarks, symbols, logos, characters, or other product/source identifiers. The sensor 17 can obtain one or more images of the ophthalmic devices 70 being examined and can transmit the obtained images to the controller 62 whereby the controller 62 may, through the use of preloaded examination software, determine the status, health, and/or quality of the ophthalmic device being examined. In particular, the software executed by the controller 62 can determine whether or not the examined ophthalmic device contains any defects. Based on this defect determination, the controller 62 can determine whether to allow the ophthalmic device 70 to be passed on from the inspection station 16 to the packaging station 72 for insertion and/or packaging within a blister pack or other commercial sale container. Alternatively, if the detected characteristic is not satisfactory, the controller 62 can make the determination to reject the examined ophthalmic device 70 and pass the rejected device 70 to the bin 24 via the transport device 22.

Other embodiments of the disclosed system 10 will be apparent to those skilled in the art from consideration of this specification. It is intended that the specification and examples be considered as exemplary only, with the true scope of the invention being indicated by the following claims.

What is claimed is:

1. An inspection system, comprising:
an inspection station configured to receive a plurality of ophthalmic devices;
a fluid supply fluidly connected to the inspection station, the fluid supply containing a working fluid; and
an ultrasonic degassing assembly configured to remove at least one bubble carried by the plurality of ophthalmic devices upstream of a packaging station.

2. The system of claim 1, wherein the ultrasonic degassing assembly comprises a power source and a probe.

3. The system of claim 1, wherein a component of the ultrasonic degassing assembly is programmably moveable relative to each device of the plurality of ophthalmic devices to assist in removing at least one bubble carried by the plurality of ophthalmic devices.

4. The system of claim 1, wherein the plurality of ophthalmic devices are submerged in the working fluid within the inspection station.

5. The system of claim 1, further including at least one sensor configured to detect a characteristic of each device of the plurality of ophthalmic devices.

6. The system of claim 1, wherein the inspection station is disposed upstream of the packaging station.

7. The system of claim 1, wherein each device of the plurality of ophthalmic devices is disposed within a respective substantially open cell of a carrying tray, the carrying tray being removably disposed upon a transport device.

8. The system of claim 1, wherein a portion of the ultrasonic degassing assembly is configured to extend within a volume of the working fluid disposed within the inspection station

9. The system of claim 1, wherein the ultrasonic degassing assembly is configured to direct ultrasonic energy to a device of the plurality of ophthalmic devices disposed within a substantially open cell of a carrying tray.

10. A method of inspecting an ophthalmic device, comprising:
disposing the ophthalmic device within a volume of working fluid;
directing ultrasonic energy to the ophthalmic device through the working fluid prior to disposing the ophthalmic device in a packaging container; and
sensing at least one characteristic of the ophthalmic device.

11. The method of claim 10, wherein directing ultrasonic energy to the ophthalmic device includes removing at least one bubble carried by the ophthalmic device.

12. The method of claim 10, wherein disposing the ophthalmic device within the volume of working fluid includes disposing the ophthalmic device within a substantially open cell of a carrying tray.

13. The method of claim 10, wherein directing ultrasonic energy to the ophthalmic device Includes submerging a portion of an ultrasonic degassing assembly within the volume of working fluid.

14. The method of claim 13, further including programmably positioning the portion of the ultrasonic degassing assembly relative to the ophthalmic device.

15. The method of claim 10, further including directing the ophthalmic device to a packaging station based on the sensed at least one characteristic.

16. The method of claim 10, wherein directing ultrasonic energy to the ophthalmic device includes creating a pressure difference between the working fluid and at least one bubble carried by the ophthalmic device.

17. The method of claim 10, wherein directing ultrasonic energy to the ophthalmic device includes increasing a dimension of at least one bubble carried by the ophthalmic device.

18. The method of claim 10, wherein directing ultrasonic energy to the ophthalmic device includes focusing the ultrasonic energy on the ophthalmic device with a probe of an ultrasonic degassing assembly.

19. A method of inspecting an ophthalmic device, comprising:
submerging a portion of a probe of an ultrasonic degassing assembly in a volume of working fluid disposed in an inspection station;
positioning the probe proximate a bubble formed within the volume of working fluid, the bubble disposed on a surface of the ophthalmic device;
directing ultrasonic energy to the bubble with the probe;
removing the portion of the probe from the volume of working fluid; and
sensing at least one characteristic of the surface.

20. The method of claim 19, further including directing the sensed ophthalmic device to a packaging station downstream of the inspection station.
